(19) United States
(12) Patent Application Publication
(10) Pub. No.: US 2011/0287712 A1
(43) Pub. Date: Nov. 24, 2011

(54) System for wireless communications through sea vessel hull

(76) Inventors: Gareth Conway, Keady (GB); Vincent William Dobbin, Gosport (GB); Brian Kearns, Dublin (IE); Brendan Hyland, Edinburgh (GB)

(21) Appl. No.: 12/782,445

(22) Filed: May 18, 2010

(51) Int. Cl. H04B 5/00

(52) U.S. Cl. 455/41.1

(57) ABSTRACT

The present invention discloses a system for wireless communications and/or data transfer through a sea-vessel hull by means of electric and/or magnetic coupling between first and second transducers located on opposing sides of the hull. Transmit and receive transducers located on opposing sides of the hull are clamped around cables which penetrate the hull and which are fed through pressure hull glands in the hull. The inductive transducers couple electric and/or magnetic signals through the sea vessel hull via paths through the pressure hull glands or via paths through the cables. The system for wireless communication and/or data transfer of the present invention is capable of operation through an electrically conductive sea vessel hull which would ordinarily present a physical barrier against the transmission of such signals. The system can be deployed on an ad ad-hoc basis and is capable of providing high data rate and high bandwidth communications and/or data transfer through the sea vessel hull. The system does not interfere with existing cabled systems penetrating the hull via the pressure hull glands. In particular, the system of the present invention requires no modification of existing hardware nor does it require any modification of the hull for operation.

### FIELD USE

The present invention relates to the field of communications through the hull of a sea vessel.

### DESCRIPTION OF THE RELATED ART

Wireless communications, data transfer and/or the transmission of control signals through the hull of a sea vessel are desirable for a range of applications. For example, on submarines, various external equipment, such as sonar, mast raising gear etc is located under the upper casing. This equipment, requires a communication means with associated internally located equipment which sends and receives data or control signals to the external equipment. Typically, the communications means between the internal and external equipment is via wired connections. Applications of wireless communications through a sea vessel hull also include systems for voice telephony or video streaming between a diver located on the outside of the vessel, and the crew located on the inside of the sea vessel. Wireless communications between the inside and the outside of the vessel hull is also desirable when the sea vessel is located in a dry dock.

Communications through a sea vessel hull, by means of acoustic signaling, is known. However, acoustic signaling has the drawback that the signal path cannot be controlled. Acoustic signaling thus suffers from the effects of multi-path interference which limits the available bandwidth for signals

Electromagnetic signaling can provide a higher bandwidth than acoustic signaling. Signaling via electromagnetic means has the benefit over acoustic signaling that the signal path is well defined. Moreover, signaling by electromagnetic means provides the opportunity to use mature protocols and systems for establishing the radio channel can operate over multiple co-existing channels without interference.

Commonly assigned United States Patent Application Publication: 2009/0156119 “Communications through a Barrier” Rhodes et al. describes a system and apparatus for communication through an electrically conductive barrier, and is incorporated herein by reference.

Nonetheless, the ferrous nature of a typical sea vessel hull creates a barrier against the transmission of electromagnetic signals through the hull. Thus, typical communications through a sea vessel hull is by means of wired links via conventional cables. Cables which feed the wired links are fed through what is commonly referred to as pressure hull glands. Pressure hull glands can have various cable entry configurations including multi-core, paired, screened paired, tripled, coaxial etc.

The ever increasing demand for electronic systems, communications, data transfer and automation etc in modern submarines produce a demand for ever increasing communications data transfer and/or control systems to be installed in existing submarines. This constant need for upgrading of systems also arises from the fact that submarines have a typical lifetime extending into decades. Pressure hull glands are the recognized method used for passing electrical wires and other cables through submarine hulls. However, retro-fitting of pressure hull glands is a costly and time consuming exercise.

A system which could add additional data transfer and/or communications channels to existing hardware installed via pressure hull glands would be highly beneficial.

### SUMMARY OF THE INVENTION

Accordingly, an object of the present invention is to provide a system for wireless communications, data transfer and/or the transmission of control signals through a sea vessel hull by wireless coupling of electric and/or magnetic signals through the hull via existing pressure hull glands penetrating the hull.

A further object of the present invention is to provide a system for wireless communications, data transfer and/or the transmission of control signals through a sea vessel hull which can deployed on the sea vessel hull without any modification thereof.

Advantageously, the system of the present invention is capable of providing high data rate and high bandwidth communications and/or data transfer through the sea vessel hull.

The present invention provides a system for wireless communications and/or data transfer through a sea-vessel hull by means of electric and/or magnetic coupling between first and second transducers located on opposing sides of the hull. Transmit and receive transducers are clamped around cables and/or other protrusions which penetrate the hull and which are fed through pressure hull glands in the hull. The inductive transducers couple electric and/or magnetic signals through the sea vessel hull via paths through the pressure hull glands. The system for wireless communication and/or data transfer of the present invention is capable of operation through an electrically conductive sea vessel hull which would ordinarily present a physical barrier against the transmission of such signals. The system can be deployed on an ad ad-hoc basis and is capable of providing high data rate and high bandwidth communications and/or data transfer through the sea vessel hull. The system does not interfere with existing cabled systems penetrating the hull via the pressure hull glands. In particular, the system of the present invention requires no modification of existing hardware nor does it require any modification of the hull for operation.

Embodiments of the present invention will now be described in detail with reference to the accompanying figures in which:

### BRIEF DESCRIPTION OF DRAWINGS

FIG. 1A shows a side view drawing of a system for wireless communications through a sea vessel hull according to a first embodiment the present invention.

FIG. 1B shows a front view drawing of a first transducer according to the system for wireless communications through a sea vessel hull depicted in FIG. 1A.

FIG. 1C shows a front view drawing of a first transducer according to the system for wireless communications through a sea vessel hull depicted in FIG. 1A comprising a pair of associated transducer coils.

FIG. 2A shows a side view drawing of a system for wireless communications through a sea vessel hull according to a second embodiment the present invention.

FIG. 2B shows a front view drawing of a first transducer according to the system for wireless communications through a sea vessel hull depicted in FIG. 2A.

FIG. 3 shows a front view drawing of a first transducer for use in a system for wireless communications through a sea vessel hull according to a third embodiment of the present invention.

FIG. 4 shows a front view drawing of a first transducer for use in a system for wireless communications through a sea vessel hull according to a fourth embodiment of the present invention.

FIG. 5 shows a drawing of a system for wireless communications through a sea vessel hull according to a fifth embodiment of the present invention comprising a transmitter a receiver and first and second inductive transducers.

FIG. 6 shows a drawing of a system for wireless communications through a sea vessel hull according to a sixth embodiment of the present invention comprising a transmitter a receiver and an inductive transducer.

FIG. 7 shows a prior art drawing of a pressure hull gland for use in the systems for communications through sea vessel hulls according to the present invention.

FIG. 8 shows a prior art arrangement for inductive coupling between first and second coils wound on opposing sides of a annular or toroidal core.

FIG. 9 shows a current coupling mechanism comprising first and second toroidal cores each having coils wound thereon and further comprising an electrically conducting rod threading both cores.

### DETAILED DESCRIPTION

According to a first aspect, the present invention provides a system for wireless communications through an electrically conductive hull of a sea vessel comprising: a first transmitter, located on a first side of said hull and comprising a first inductive transducer, a first receiver located on a second side of said hull and comprising a second inductive transducer, an access point penetrating said hull from said first side to said second side; wherein, during operation, said access point of said hull provides a path for coupling electric and/or magnetic signals from said first transmitter to said first receiver through said sea vessel hull via said first and second inductive transducers.

In some embodiments, the system of the present invention further comprises a second transmitter located on said second side of said hull, and a second receiver located on said first side of said hull, said first transmitter and receiver and said second transmitter and receiver providing two way communications and/or data transfer through said sea vessel hull via said first and said second inductive transducers. Said first transmitter and said second receiver are may be connected to said first inductive transducer via a switch, similarly, said second transmitter and said first receiver are may be connected to said second inductive transducer via a switch.

In some embodiments, at least one of said first and second inductive transducers is divided into two sub-sections so that said at least one inductive transducer can be mounted around an elongate protrusion from said access point.

In one embodiment, each said first and said second inductive transducers comprises a respective first and second annular core where said first inductive transducer comprises an associated transducer coil wound around a portion of said first annular core and said second inductive transducer comprises an associated transducer coil wound around a portion of said second annular core. At least one of said first and second annular cores may be a toroidal core. Preferably, at least one of said first and second annular cores further comprises two sub-sections which, in use, are assembled around said access point so that a protruding cable of said access point passes through the centre of said at least one annular core. Separate associated transducer coils may be wound around each sub-section of said at least one annular core. Preferably, said access point comprises a cable gland feeding at least one cable from said first side to said second side of said hull. Said access point may also comprise a flange of an electrically non-conductive material.

During operation, input signals of said first transducer are electrically coupled to said second transducer via said at least one cable. In some embodiments, signals of said first transducer are electrically coupled to said second transducer via a metal screen of said at least one cable. At least one of said first and second annular cores may be formed of a material having a high magnetic permeability.

In another embodiment at least one of said first and said second inductive transducers comprises a core having first and second sides and further comprises an inner annular portion, an outer annular portion concentric with said inner annular portion, and a flange portion bridging said inner and said outer annular portions at said first sides of said core. Preferably, said core is formed of a material having a high magnetic permeability. Said core may comprise two sub-sections which, in use are assembled around said access point.

Preferably, a transducer coil is formed around said inner annular portion of said core. Said transducer coil may further comprise pairs of mateable connectors at opposite sides thereof so that said coil can be mounted over an elongate protrusion from said access point.

During operation input signals of said first transducer are magnetically coupled to said second transducer via a flange of said access point formed of an electrically non-conductive material. Said second side of said core may be arranged so that it is flush against said sea vessel hull.

In some embodiments, the system for wireless communications of the present invention, further comprises an input device for inputting control, communications and/or data signals to said first transmitter.

In some embodiments, the system for wireless communications of the present invention, further comprises an output device for outputting control, communications and/or data signals received by said first receiver from said first transmitter.

Electrical signals can be inductively coupled from a first transducer coil to a second transducer coil via induced magnetic fields even when there is no direct contact between the coils of the transducers. For example, the induced magnetic fields may be coupled between the transducers via a common core of both transducers. Such an arrangement is the basis upon which an electrical transformer operates. The core of a transformer has a wide range of alternative designs options; an annular core, having one or more elongated sections, connecting together and forming a closed loop is one such option. A toroidal core which is formed by rotation of a 2D cross section through 360 degrees about an axis which does not intersect the 2D cross section is another option.

A common material for use in magnetic cores is ferrite. For example, transformers comprising ferrite cores are used in applications having frequencies over a very wide range. Limiting values for operation of ferrite cores range from a lower extreme of approximately 1 Hz, to an upper extreme of approximately 100 MHz.

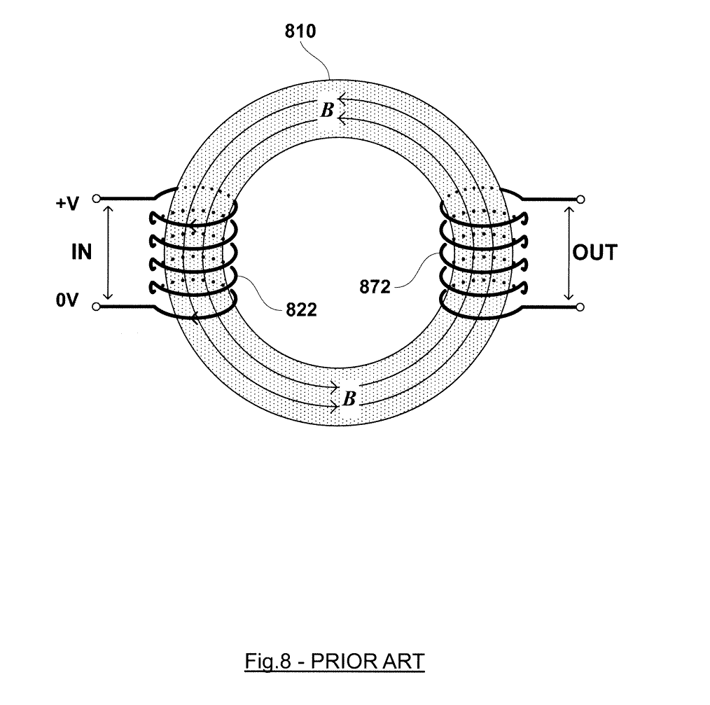

In the simplest embodiment, an inductive coupling mechanism comprises first and second coils would on opposing sides of an annular or toroidal core. FIG. 8 shows such an arrangement. The toroidal core 810 provides a path for a magnetic field induced by the first coil 822 so the field also threads through the second coil 872. In operation, an alternating current in the first coil 822 induces an alternating magnetic field in the core 810. The same alternating magnetic field passes through the second coil 872 via the core 810. From Faraday's law of electromagnetic induction, an alternating magnetic field threading a coil produces an alternating current in the coil; thus, an alternating current is produced in the second coil 872. The ratio of the current in the first and second coils is determined by the number of windings in each coil and the efficiency of coupling the magnetic field induced by the first coil to the second coil.

Magnetic fields can also be coupled between first and second inductive elements which are physically separated and which do not share a common core. The degree of coupling depends mostly on the geometry and nature of the material between the coils. Magnetic fields always form a closed path, and substantially follow the path offering the lowest magnetic reluctance.

According to a similar analysis, magnetic signals can be coupled from a first transducer to a second transducer via induced currents even when there is no direct contact between the pair of transducers.

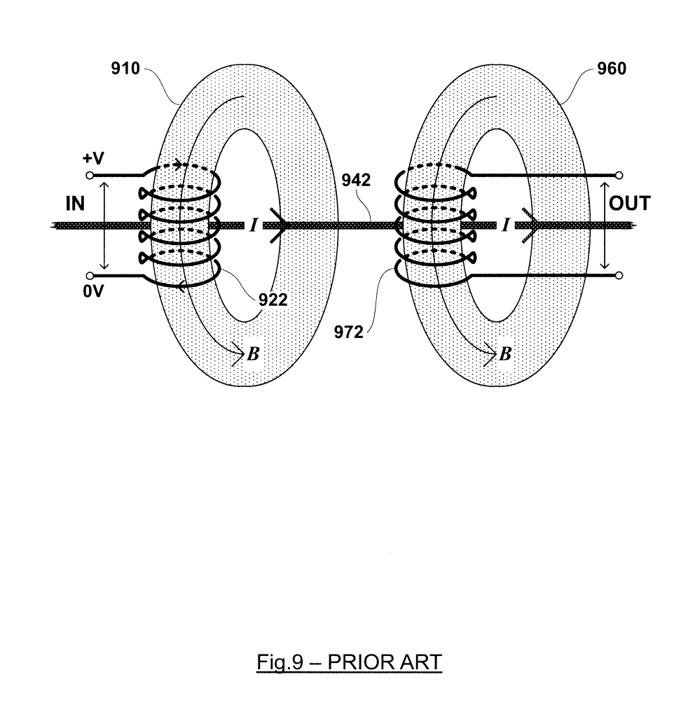

Circular magnetic fields in an annular or toroidal core may be coupled between a pair of transducers via a conducting rod which threads both transducers. For example, a current coupling mechanism might comprise first and second coils would on first and second toroidal cores and having an electrically conducting rod which threads both cores. FIG. 9 shows such an arrangement; the electrically conducting rod 942 which threads both toroidal cores 910, 960 provides a path for a coupled electrical current I. In operation, an alternating current in the first coil 922 induces a circular magnetic field in the first core B, this induces an alternating current in the electrically conducting rod 942. The alternating current in the electrically conducting rod 942 produces a corresponding circular alternating magnetic field in the second toroidal core 960, and this alternating field threading the second toroidal core 960 produces an alternating current in the second coil 972. The ratio of the current in the first and second coils 922, 972 is determined by the number of windings in each coil and the efficiency of coupling between the magnetic field in the first core to the electrically conductive wire.

Coupling of a magnetic field through a sea vessel hull is difficult to achieve due to the typically conductive material used for the hull. A magnetic field induced by a first coil located on one side of the hull, will find a low reluctance closed path via the core of the first coil and back via the ferrous hull. However, magnetic fields can be coupled from a first side of a sea vessel hull to the second side through the sea vessel hull if the low reluctance path for magnetic fields via the ferrous hull is eliminated. A penetration in the sea vessel hull provides just such a path if the cores of the transducers located on opposing sides of the hull are carefully designed.

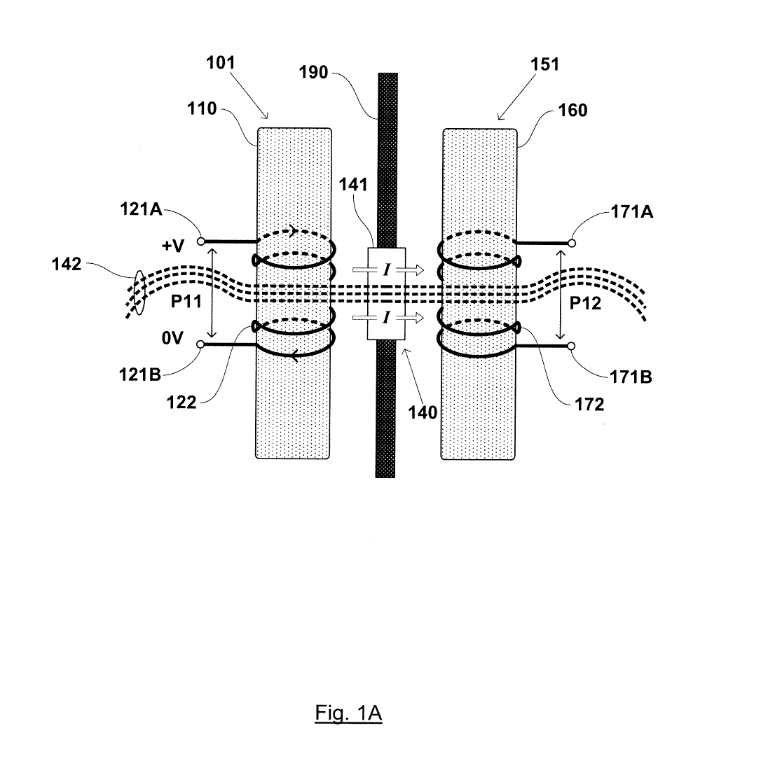

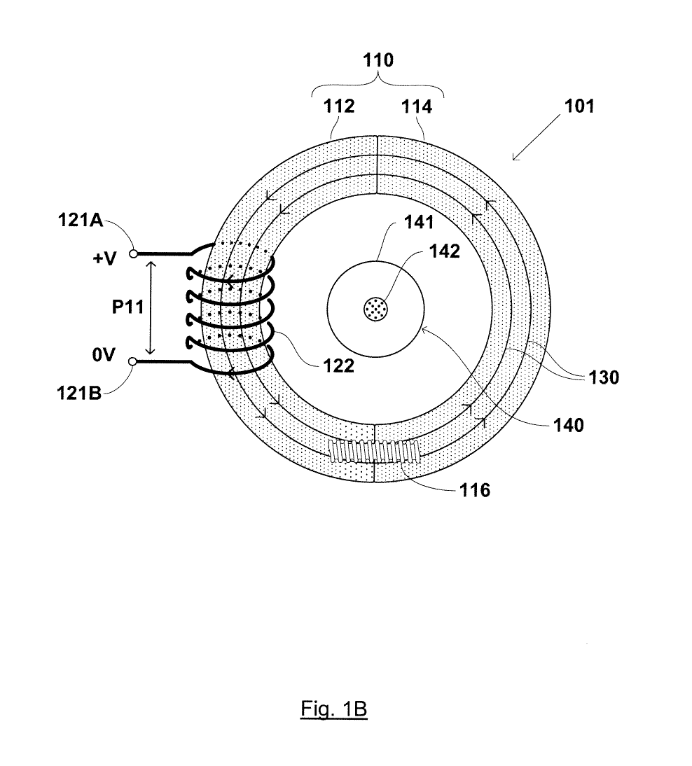

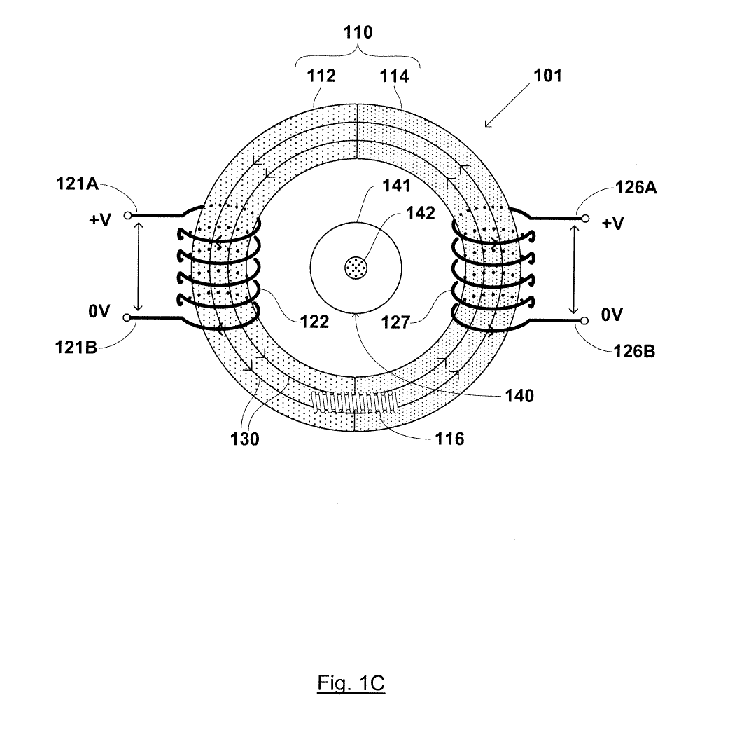

FIG. 1A shows a side view drawing of a system for wireless communications through a sea vessel hull 190 according to a first embodiment of the present invention. The generic term communications here and elsewhere implicitly refers to any or all of: transmission and/or reception of communications signals, transmission and/or reception of control signals and transmission and/or reception of data.

The system of FIG. 1A comprises a first transducer 101 comprising a first transducer coil 122 formed over a magnetic permeable toroidal core 110. First transducer coil 122 is wound of electrically conductive wire having an electrically insulating outer coating. First transducer coil 122 comprises input terminals 121A, 121B across which a voltage differential V may be applied. First transducer 101 is located so that the plane of toroidal core 110 is parallel to the plane of sea vessel hull 190. During use, one side of toroidal core 101 is positioned so that it is close to or flush against sea vessel hull 190 and so that the centre axis of toroidal core 110 intersects the centre point of pressure hull gland 140. Pressure hull gland 140 comprises flange 141 and cable bundle 142 which penetrates flange 141.

A second transducer 151 is positioned on the opposite side of sea vessel hull 190, and is in register with first transducer 101. Second transducer 151 comprises a second transducer coil 172 formed over a toroidal core 160. Second transducer coil 172 comprises output terminals 171A, 171B.

First and second toroidal cores 110, 160 may be formed from a wide range of alternative materials. A material having a high relative magnetic permeability is preferable. One specific material which may be used for magnetic cores 110, 160 is ferrite. Ferrite is commonly used for transformer and inductor cores because of its high magnetic permeability. Ferrite is suitable for use in applications requiring the coupling of magnetic fields having frequencies ranging from a lower extreme of approximately 1 Hz, to an upper extreme of approximately 100 MHz.

FIG. 1B shows a front view drawing of first transducer 101 according to the system for wireless communications through a sea vessel hull embodying the present invention and depicted in FIG. 1A.

Toroidal core 110 is split into two identical sub-sections 112, 114. To assemble toroidal core 110, the two sections 112, 114 are affixed to each other by threaded screw 116. The two sections 112, 114 of toroidal core 110 may alternatively be fixed to each other by an alternative means.

When assembled, transducer 101 fits around a pressure hull gland 140 of sea vessel hull 190 (FIG. 1A). Pressure hull gland comprises flange 141 and cable bundle 142 which penetrates flange 141. The split structure of toroidal core 110 comprising sections 112, 114 enables first transducer 101 to be assembled so that it fits around an existing cable which protrudes from cable gland 140 and which penetrates sea vessel hull 190. Thus, first transducer 101 can be deployed around pressure hull gland 140 without any modification thereof, without any modification of the cable bundle 142 passing through pressure hull gland 140 or without any modification of the sea vessel hull 190.

First transducer coil 122 is wound around one of the two sections 112, 114 of toroidal core 110 and is formed of electrically conductive wire having an insulating coating. A current entering first transducer coil 122 at terminal 121A, and exiting at terminal 121B, induces a magnetic field in toroidal core 110 which follows the path and direction of magnetic field lines 130.

Cable bundle 142 may comprise several cables, but nonetheless occupies only a portion of the area occupied by flange 141 of pressure hull gland 140. Ideally, cable bundle 142 comprises one or more screened cables.

In use, an electrical signal is fed to port P11 of first transducer 101. The electrical signal induces a circular magnetic field in first transducer core 110, which induces a corresponding electrical signal in the screen of at least one of cable bundle 142. The current flowing in the screen of at least one of cable bundle 142 induces a circular magnetic field in second transducer core 160 (FIG. 1A). This, in turn, induces a current in second transducer coil 172, which may be detected using conventional electronic communications equipment. Input electrical signals may have carrier frequencies ranging from 1 Hz, to 100 MHz.

The one or more screened cables of cable bundle 142 are ideally grounded on the inside and on the outside of sea vessel hull 190. For example, one or more of the cables of cable bundle 142 may be grounded either directly to earth or indirectly via the electrically conductive sea water on the outside of the hull, and may also be grounded to the vessel hull at some point on the inside thereof. Direct or indirect grounding of one or more of cable bundle 142 provides an improved coupling of electrical signals from first transducer 101 to second transducer 151.

FIG. 1C shows a front view drawing of first transducer 101 according to the system for wireless communications through a sea vessel hull depicted in FIG. 1A comprising a pair of associated transducer coils.

The transducer depicted in FIG. 1C is identical to that of FIG. 18, except that a pair of associated transducer coils 122, 127 are provided instead of the single transducer coil 122 for the transducer shown in FIG. 1B. Transducer coil 127 comprises input terminals 126A, 126B, across which a voltage differential V may be applied. In use, electrical signals are fed to terminals 121A, 1218 and 126A, 126B so that magnetic field lines 130 produced by each of associated transducer coils 122, 127 are aligned.

Passing electrical currents through of a pair of transducer coils 122, 127 as shown in FIG. 10 provides an increased magnetic field inside toroidal core 110, when compared with a transducer comprising only a single coil 122 (FIG. 1B).

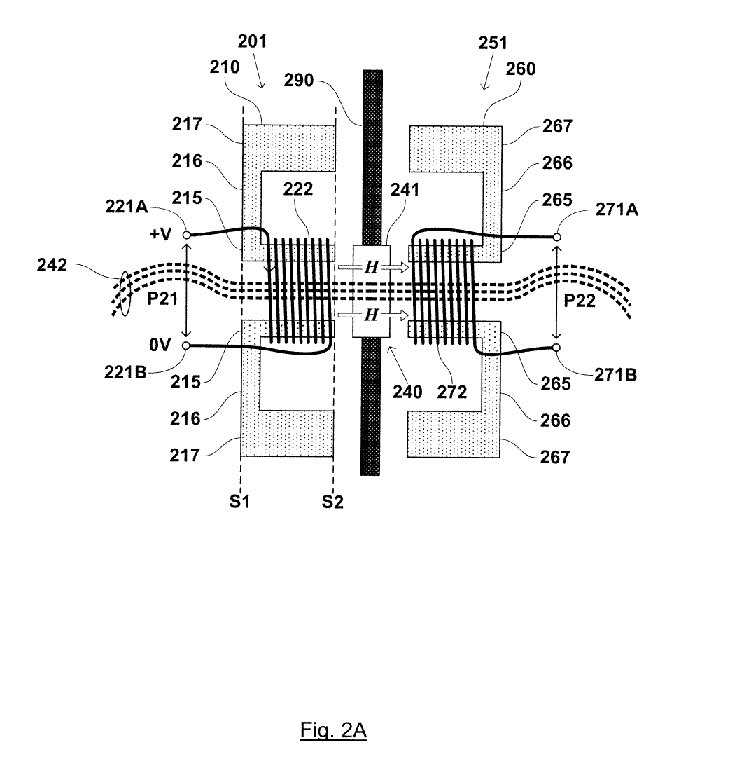

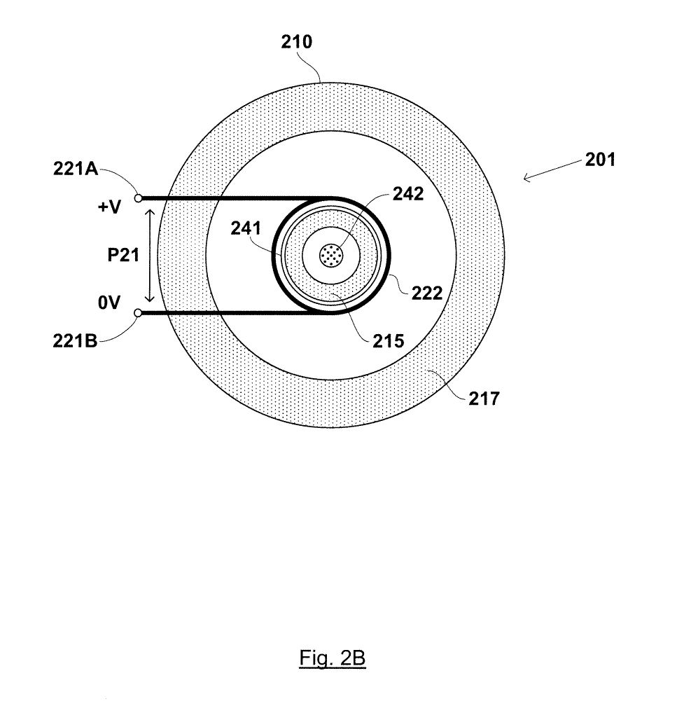

FIG. 2A shows a side view drawing of a system for wireless communications through a sea vessel hull according to a second embodiment the present invention.

The system of FIG. 2A comprises a first transducer 201. First transducer 201 comprises a first transducer coil 222 formed of electrically conductive wire and having an electrically insulating outer coating. Coil 222 is wound over a portion of magnetic permeable annular core 210.

Annular core 210 has a first side S1 and a second side S2, both sides S1, S2 being perpendicular to a central axis of annular core 210. First side S1 faces away from sea vessel hull 290, and second side S2 faces towards sea vessel hull 290. Annular core 210 comprises three sections: an inner annular portion 215, an outer annular portion 217 and a flange portion 216. Flange portion 216 bridges between inner annular portion 215 and outer annular portion 217 at the first side S1 of annular core 210.

Annular core 260, similarly, has a first side and a second side (not shown), both sides being perpendicular to a central axis of annular core 260 where the first side faces away from sea vessel hull 290, and the second side faces towards sea vessel hull 290. Annular core 260 comprises three sections: an inner annular portion 265, an outer annular portion 267 and a flange portion 266. Flange portion 266 bridges between inner annular portion 265 and outer annular portion 267 at the first side of annular core 260.

In use, first transducer 201 is positioned so that the first side S1 is parallel to the plane of sea vessel hull 290 and is close to or is flush against sea vessel hull 290. First transducer 201 is optimally positioned when a central axis of annular core 210 intersects the centre point of pressure hull gland 240. Pressure hull gland 240 comprises flange 241 and cable bundle 242 which penetrates flange 241 and which similarly penetrates sea vessel hull 290. In general, the material of flange 241 is a poor conductor of electricity. Flange 241 may be formed of an electrically insulating material such as polyethylene.

First transducer coil 222 comprises input terminals 221A, 221B across which a voltage differential V may be applied.

In use, a time varying electrical signal is fed to port P21 of first transducer 201. The electrical signal induces an alternating magnetic field H in annular core 210 of first transducer 201, which couples to annular core 260 of second transducer 251. The alternating magnetic field in annular core 260, induces an alternating current in second transducer coil 272. This current in second transducer coil 272 may be received and/or detected using conventional electronic communications equipment.

FIG. 2B shows a front view drawing of first transducer 201 according to the system for wireless communications through a sea vessel hull embodying the present invention and depicted in FIG. 2A.

A current entering first transducer coil 222 at terminal 221A, and exiting at terminal 221B, produces a magnetic field (not shown) following a path which is perpendicular to and directed towards the plane of the drawing.

The induced magnetic field follows a path through the electrically insulating material of flange 241 to annular core (260 FIG. 2A) of second transducer (251 FIG. 2A) located on the far side of sea vessel hull 290.

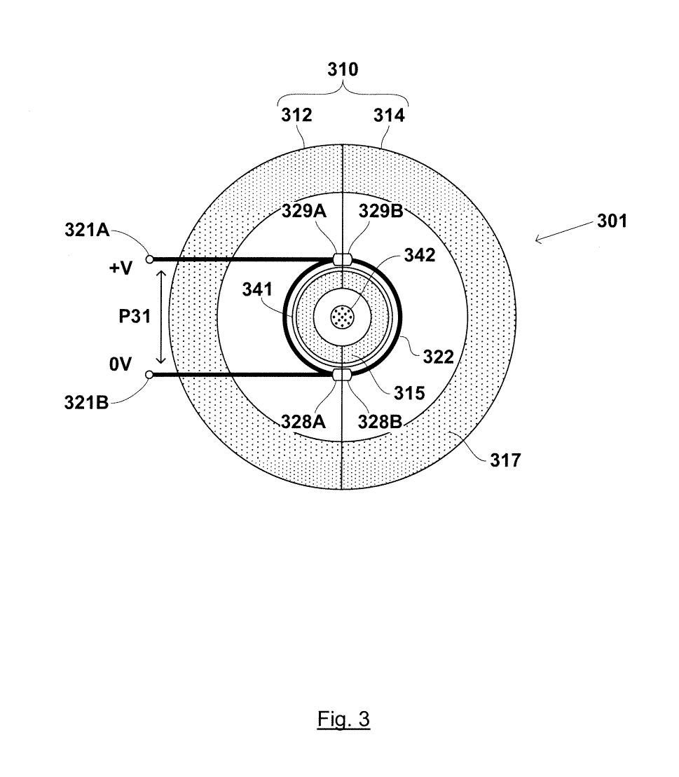

FIG. 3 shows a front view drawing of first transducer 301 for use in a system for wireless communications through a sea vessel hull according to a third embodiment of the present invention.

Annular core 310 of FIG. 3 comprises three portions: an inner annular portion 315, an outer annular portion 317 and a flange portion (not shown) which bridges between inner annular portion 315 and outer annular portion 317.

Annular core 310 further can be divided into a pair of substantially equal sub-sections: first section 312 and second section 314. First section 312 and second section 314 may be secured together by a fixing bolt (not shown).

Transducer coil 322 is wound around inner annular portion 315 of annular core 310. Transducer coil 322 is formed of electrically conductive wire having an electrically insulating outer coating. Transducer coil 322 comprises input terminals 321A, 321B across which a voltage differential V may be applied.

Transducer coil 322 further comprises a first plug and socket pair 328A, 3286 and a second plug and socket pair 329A, 3298. Each plug and socket pair 328A, 328B and 328A, 328B is disposed at opposing sides of transducer coil 322. Plug and socket pairs 328A, 328B and 328A, 328B facilitate the separation of transducer coil 322 into two sections which can be clamped around a pressure hull gland of a sea vessel hull. Advantageously, each plug and socket pair 328A, 328B and 328A, 328B of transducer coil 322 are designed so that when fitted together they exclude water.

Transducer 301 is fixed around pressure hull gland comprising flange 341 and cable bundle 342 which penetrates a sea vessel hull. Transducer 301 is optimally positioned when a central axis of annular core 310 intersects the centers of pressure hull gland flange 341 and cable bundle 342.

Transducer 301 might be used, for example, as one part of a communications system, comprising transducer 201 of FIG. 2A and FIG. 2B. For example, transducer 301 could be clamped around pressure hull gland 240 of FIG. 2A of the present invention in place of transducer 201. Alternatively, a system for wireless communications through a sea vessel hull might comprise a pair of transducers 301 positioned on opposite sides of the hull, each transducer being positioned around a pressure hull gland.

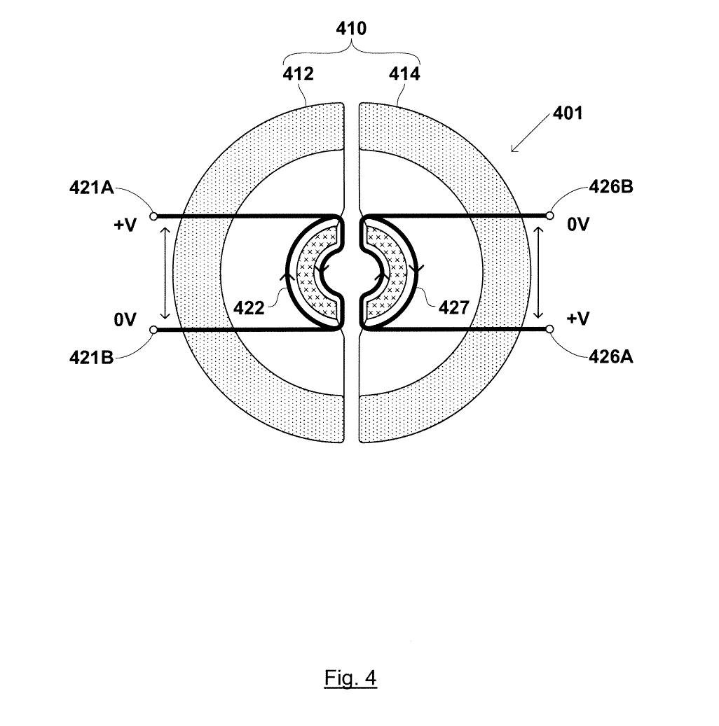

FIG. 4 shows a front view drawing of first transducer 401 for use in a system for wireless communications through a sea vessel hull according to a fourth embodiment of the present invention.

Transducer 401 comprises annular core 410 which can be divided into a pair of substantially equal sections: first section 412 and second section 414. First section 412 and second section 414 of annular core 410 may be secured together by a fixing bolt or some other securing means (not shown).

Transducer 401 further comprises first transducer coil 422 and second transducer coil 427. First transducer coil 422 and second transducer coil 427 are respectively wound over inner annular portions of first core section 412 and second core section 414 of magnetic permeable annular core 410. Advantageously, during use, transducer coil 422 and second transducer coil 427 are electrically connected together in parallel.

First and second transducer coils 422, 472 are wound of electrically conductive wire having an electrically insulating outer coating. First transducer coil 422 comprises input terminals 421A, 421B across which a voltage differential V may be applied. Second transducer coil 427 comprises input terminals 426A, 426B across which a voltage differential V may be applied. Voltages are applied to input terminals 421A, 421B of first coil 422 and to input terminals 426A, 426B of second coil 427 so that magnetic fields induced in the enclosed areas of each of first and second coils 422, 427 constructively interfere. The direction of current flow in transducer coils 422 and 427 is represented by arrows in FIG. 4. This arrangement ensures that induced magnetic field pass through the inner annular portions of first core section 412 and second core section 414. The induced magnetic fields point in a direction which is perpendicular to the plane of FIG. 4 and are represented by arrays of the letter X drawn inside the inner annular portions of first and second core sections 412 and 414.

In use, electrical signals are fed to input terminals 421A and 421B of first transducer coil and input terminals 461A and 462B of second transducer coil 427. The magnetic fields induced in the inner annular portions of first core section 412 and second core section 414 are coupled to a core of second transducer located on the opposite side of a sea vessel hull (not shown). The induced magnetic field follows a path through a pressure hull gland (not shown).

Transducer 401 might be used, for example, as one part of a communications system, comprising transducer 201 of FIG. 2A and FIG. 2B. Alternatively, a system for wireless communications through a sea vessel hull might comprise a pair of transducers 401 positioned on opposite sides of the hull, each transducer being positioned around a pressure hull gland.

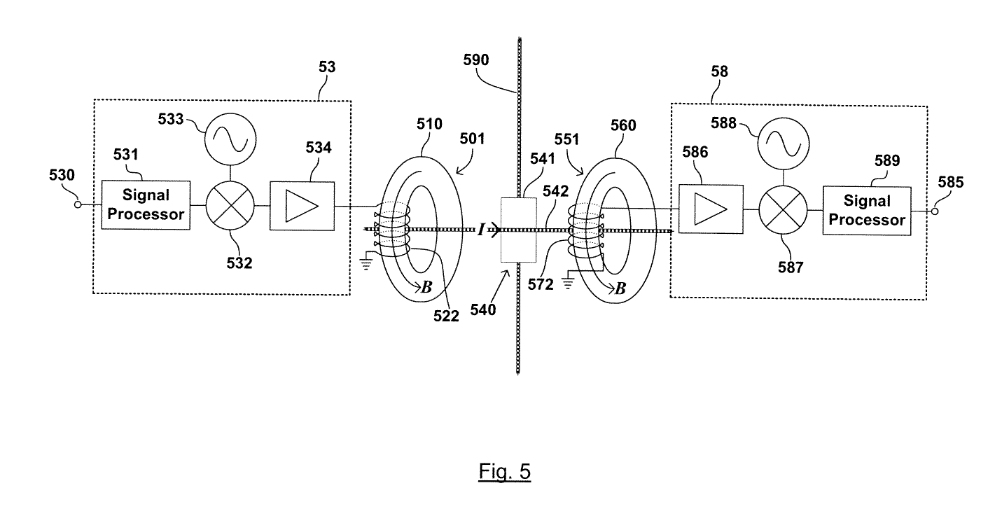

FIG. 5 shows a drawing of a system for wireless communications through a sea vessel hull according to a fifth embodiment of the present invention comprising a transmitter 53 a receiver 58 and respective first and second inductive transducers 501, 551. The system further comprises a pressure hull gland 540, having a flange 541 of an electrically non-conductive material, and a cable bundle 542 passing through pressure hull gland 540. Inductive transducer 501 is electrically connected to transmitter 53 and inductive transducer 551 is electrically connected receiver 58.

Transmitter 53 comprises an input port 530. Input signals fed to input port 530 may comprise any of voice or video signals, images, control signals or data. A suitable input device (not shown), which provides voice signals, video signals, images, control signals or data signals, as appropriate is connected to input port 530. Such input devices are well known to those skilled in the art.

During operation, an input signal is passed to processor 531 where it is encoded and modulated for transmission in accordance with the transmission system to be used. The encoded signal is output from processor 531, where it is fed to mixer 532, to be mixed with a signal generated by local oscillator 533 for frequency up-conversion. The frequency up-converted signal is then amplified by amplifier 534 and fed to first transducer 501.

First transducer 501 comprises annular core 510, and associated coil 522. Second transducer 551 comprises annular core 560, and associated coil 572. First transducer 501 is placed near or adjacent to sea-vessel hull 590, and is assembled around a pressure hull gland 540, so that a cable 542 protruding from pressure hull gland threads the centre of annular core 510. The input signal fed to transducer 501 induces an alternating magnetic field in core 510, which, in turn, induces an alternating current in one or more of the cables in cable bundle 542.

The alternating current induced in cable bundle 542 induces a corresponding signal in second transducer 551 which is received by receiver 58. Thus, transmission and reception of the input signal is by means of electrical coupling of the signal in one or more of the cables in cable bundle 542 and is via a path through pressure hull gland 540.

The signal which is received by transducer 551, is passed to amplifier 586. The amplified signal is fed to mixer 587, to be mixed with another signal generated by local oscillator 588 for frequency down conversion. The down converted data signal is then passed to processor 589 where it is demodulated and decoded and output at output port 685.

Receiver 58 also comprises an output port 585. A suitable output device (not shown), which outputs voice signals, video signals, images, control signals or data signals, as appropriate and as would be known to a person skilled in the art, is connected to output port 655. Output signals might comprise any of voice or video signals, images, control signals or data.

Input and output devices for use with the embodiment of the present invention depicted in FIG. 5 might include, microphones, cameras, video cameras, personal computers, communications handsets, or any device which provides an input and/or output electrical signal.

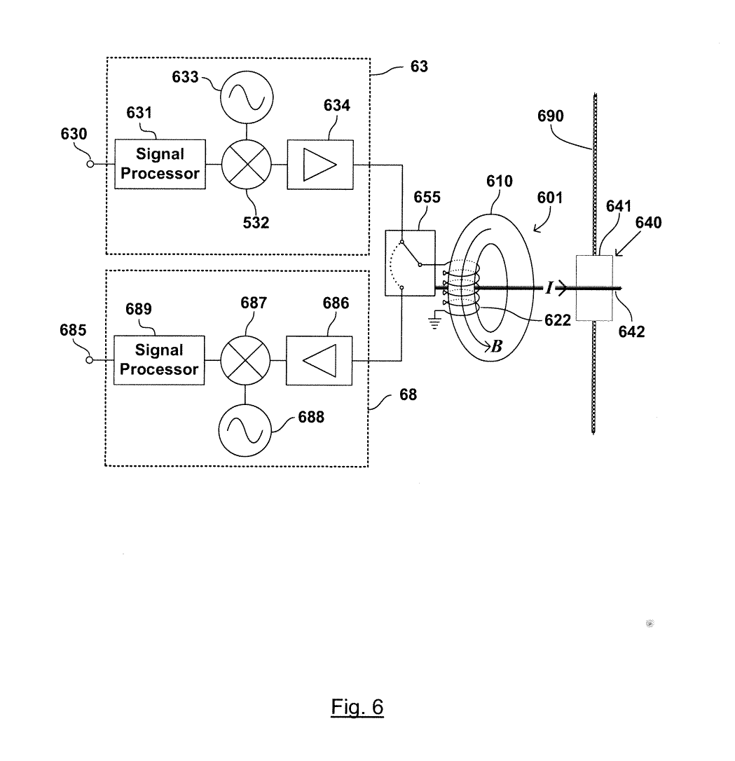

FIG. 6 shows a drawing of a system for wireless communications through a sea vessel hull according to a sixth embodiment of the present invention comprising a transmitter 63 a receiver 68 and an inductive transducer 601. Inductive transducer 601 is connected to transmitter 63 and receiver 68 via switch 655. In use, switch 655 is set to connect transmitter 63 with transducer 601 when signals are to be transmitter, and is set to connect receiver 64 to transducer 601 when signals are to be received.

Transmitter 63 comprises an input port 630. Input signals fed to input port 630 may comprise any of voice or video signals, images, control signals or data. A suitable input device (not shown), which provides voice signals, video signals, images, control signals or data signals, as appropriate is connected to input port 630. Such input devices are well known to those skilled in the art.

During operation, the input signal is passed to processor 631 where it is encoded and modulated for transmission in accordance with the transmission system to be used. The encoded signal is output from processor 631, where it is fed to mixer 632, to be mixed with a signal generated by local oscillator 633 for frequency up-conversion. The frequency up-converted signal is then amplified by amplifier 634 and fed to first transducer 601 via switch 655.

Receiver 68 comprises an output port 685. Output signals might comprise any of voice or video signals, images, control signals or data according to the signal received by transducer 601. A suitable output device (not shown), which outputs voice signals, video signals, images, control signals or data signals, as appropriate and as would be known to a person skilled in the art, is connected to output port 685.

During operation, a signal is received by transducer 601, is passed to amplifier 686 via switch 655 where it is amplified. The amplified signal is fed to mixer 687, to be mixed with a signal generated by local oscillator 688 for frequency down conversion. The down converted data signal is then passed to processor 689 where it is demodulated and decoded and output at output port 685.

First transducer 601 comprises annular core 610, and associated coil 622. During operation, first transducer 601 is placed near or adjacent to sea-vessel hull 690, and is assembled around a pressure hull gland 640, so that a cable 642 protruding from pressure hull gland threads the centre of annular core 610. The alternating signals fed to transducer 610 induce alternating magnetic fields in core 610, which, in turn, induce alternating currents in cable 642.

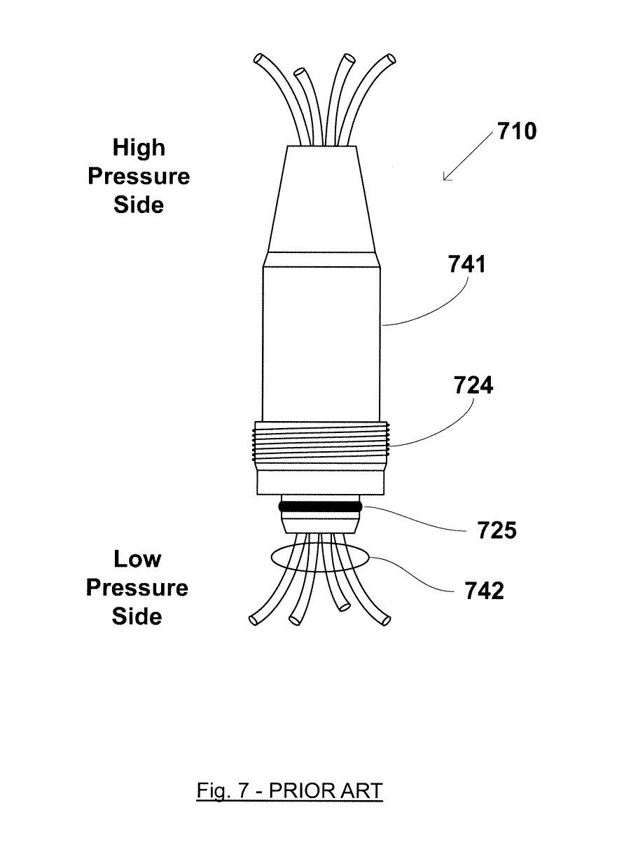

FIG. 7 shows a prior art drawing of a pressure hull gland 710 for use in the systems for wireless communications through sea vessel hulls according to the present invention. Pressure hull gland has a high pressure side and a low pressure side. The high pressure side can withstand the high pressures that exist on the outside of a sea vessel hull which is submerged well below the surface of the sea.

Passing through the centre of pressure hull gland 710 is a cable gland 742, which accommodates one or more cables. Cables which pass through cable gland 742 may include: cables carrying electrical data signals, cables carrying electrical control signals or cables carrying communications signals.

A main body of pressure hull gland 741 is formed of an electrically non-conducting material. A suitable material for the main body of pressure hull gland 741 is polyethylene. Pressure hull gland 710 additionally comprises a threaded flange 724 and an O-ring 725. Threaded flange 724 and O-ring 725 provide a water tight seal in the hull of the sea vessel where pressure hull gland 710 is installed.

The systems for communications through sea vessel hulls of the present invention are particularly suited to underwater communications and/or data transfer by electric and/or magnetic signals having frequencies in the range from 1 Hz to 100 MHz.

Thus, the present invention, embodied in the various figures and descriptions described herein, provides a system for wireless communications, data and/or control signal transmission through a sea vessel hull by coupling of electric and or magnetic signals through the hull via existing pressure hull glands penetrating the hull. The system of the present invention can be deployed on the sea vessel hull without any modification thereof. Moreover, the system of the present invention is capable of providing high data rate and high bandwidth communications and/or data transfer through the sea vessel hull.

The descriptions of the specific embodiments herein are made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

What is claimed is:

1. A system for wireless communications through an electrically conductive hull of a sea vessel comprising:
a first transmitter, located on a first side of said hull and comprising a first inductive transducer, a first receiver located on a second side of said hull and comprising a second inductive transducer, an access point penetrating said hull from said first side to said second side;
wherein, during operation, said access point of said hull provides a path for coupling electric and/or magnetic signals from said first transmitter to said first receiver through said sea vessel hull via said first and second inductive transducers.

2. A system for wireless communications through a sea vessel hull according to claim 1, further comprising a second transmitter located on said second side of said hull, and a second receiver located on said first side of said hull, said first transmitter and receiver and said second transmitter and receiver providing two way communications and/or data transfer through said sea vessel hull via said first and said second inductive transducers.

3. A system for wireless communications through a sea vessel hull according to claim 1, wherein at least one of said first and second inductive transducers is divided into two sub-sections so that said at least one inductive transducer can be mounted around an elongate protrusion from said access point.

4. A system for wireless communications through a sea vessel hull according to claim 1, wherein said access point comprises a cable gland feeding at least one cable from said first side to said second side of said hull.

5. A system for wireless communications through a sea vessel hull according to claim 1, wherein said access point comprises a flange of an electrically non-conductive material.

6. A system for wireless communications through a sea vessel hull according to claim 1, wherein each said first and said second inductive transducers comprises a respective first and second annular core;
said first inductive transducer comprising an associated transducer coil wound around a portion of said first annular core and said second inductive transducer comprising an associated transducer coil wound around a portion of said second annular core.

7. A system for wireless communications through a sea vessel hull according to claim 6, wherein at least one of said first and second annular cores comprises two sub-sections which, in use, are assembled around said access point so that a protruding cable of said access point passes through the centre of said at least one annular core.

8. A system for wireless communications through a sea vessel hull according to claim 7, comprising separate associated transducer coils wound around each sub-section of said at least one annular core.

9. A system for wireless communications through a sea vessel hull according to claim 4, wherein, during operation, input signals of said first transducer are electrically coupled to said second transducer via said at least one cable.

10. A system for wireless communications through a sea vessel hull according to claim 4, wherein, during operation, input signals of said first transducer are electrically coupled to said second transducer via a metal screen of said at least one cable.

11. A system for wireless communications through a sea vessel hull according to claim 6 wherein at least one of said first and second annular cores is formed of a material having a high magnetic permeability.

12. A system for wireless communications through a sea vessel hull according to claim 6 wherein at least one of said first and second annular cores is a toroidal core.

13. A system for wireless communications through a sea vessel hull according to claim 1, wherein at least one of said first and said second inductive transducers comprises a core having first and second sides and further comprises an inner annular portion, an outer annular portion concentric with said inner annular portion, and a flange portion bridging said inner and said outer annular portions at said first sides of said core.

14. A system for wireless communications through a sea vessel hull according to claim 13 wherein said core comprises two sub-sections which, in use are assembled around said access point.

15. A system for wireless communications through a sea vessel hull according to claim 13, wherein an associated transducer coil is formed around said inner annular portion of said core.

16. A system for wireless communications through a sea vessel hull according to claim 13, wherein said associated transducer coil comprises pairs of mateable connectors at opposite sides thereof so that said coil can be mounted over an elongate protrusion from said access point.

17. A system for wireless communications through a sea vessel hull according to claim 5, wherein input signals of said first transducer are magnetically coupled to said second transducer via said flange.

18. A system for wireless communications through a sea vessel hull according to claim 13, wherein during use said second side of said core is flush against said sea vessel hull.

19. A system for wireless communications through a sea vessel hull according to claim 13, wherein said core is formed of a material having a high magnetic permeability.

20. A system for wireless communications through a sea vessel hull according to claim 2, wherein said first transmitter and said second receiver are connected to said first inductive transducer via a switch.

21. A system for wireless communications through a sea vessel hull according to claim 2, wherein said second transmitter and said first receiver are connected to said second inductive transducer via a switch.

22. A system for wireless communications through a sea vessel hull according to claim 1, further comprising an input device for inputting control, communications and/or data signals to said first transmitter.

23. A system for wireless communications through a sea vessel hull according to claim 1, further comprising an output device for outputting control, communications and/or data signals received by said first receiver from said first transmitter.

24. A system for wireless communications through a sea vessel hull according to claim 1 wherein said electric and/or magnetic signals have carrier frequencies ranging from 1 Hz, to 100 MHz.
